(19) United States
(12) Patent Application Publication
(10) Pub. No.: US 2019/0384557 A1
(43) Pub. Date: Dec. 19, 2019

(54) EMULATED MULTI-SCREEN DISPLAY DEVICE

(71) Applicant: Microsoft Technology Licensing, LLC, Redmond, WA (US)

(72) Inventor: Steven D. OTTESON, Redmond, WA (US)

(73) Assignee: Microsoft Technology Licensing, LLC, Redmond, WA (US)

(21) Appl. No.: 16/009,791

(22) Filed: Jun. 15, 2018

(51) Int. Cl. G06F 3/147; G06F 3/0481; G06F 3/0484; G06F 3/0488; G06F 9/455; G06F 9/451

(52) U.S. Cl. CPC G06F 3/147; G06F 3/04815; G06F 9/451; G06F 3/0488; G06F 9/45504; G06F 3/04845

(57) ABSTRACT

A computing device is provided, including one or more input devices, a display, and a processor. The processor may execute an emulator application program. The processor may output for display on the display a graphical user interface (GUI) of the emulator application program. The GUI may a three-dimensional graphical representation of an emulated multi-screen display device including at least a first screen and a second screen. The processor may receive a pose modification input via an input device of the one or more input devices. In response to receiving the pose modification input, the processor may modify a pose of the first screen relative to the second screen. The processor may output the GUI, including the three-dimensional graphical representation of the emulated multi-screen display device with the modified pose, for display on the display.

### BACKGROUND

When a developer writes code designed to be run on a device other than the device at which the code is written, the developer may use an emulator to test the code. The emulator may run on the device at which the developer writes the code and may simulate the behavior of the device on which the code is intended to be executed.

However, the behavior of some devices is difficult to represent on existing emulators in a form that can be quickly and easily understood by developers and testers. For example, if the device on which the emulator is run does not include all the input devices or output devices included in the emulated device, existing emulators may not accurately represent the experience of using the emulated device. Thus, it may be difficult for developers and testers to determine whether the emulated device is behaving as intended.

### SUMMARY

According to one aspect of the present disclosure, a computing device is provided, including one or more input devices, a display, and a processor. The processor may be configured to execute an emulator application program. The processor may be further configured to output for display on the display a graphical user interface (GUI) of the emulator application program. The GUI may include a three-dimensional graphical representation of an emulated multi-screen display device including at least a first screen and a second screen. The processor may be further configured to receive a pose modification input via an input device of the one or more input devices. In response to receiving the pose modification input, the processor may be further configured to modify a pose of the first screen of the emulated multi-screen display device relative to the second screen of the emulated multi-screen display device. The processor may be further configured to output the GUI, including the three-dimensional graphical representation of the emulated multi-screen display device with the modified pose, for display on the display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a computing device including a processor configured to execute an emulator application program, according to one embodiment of the present disclosure.

FIGS. 2A-2D show an example multi-screen display device that may be emulated by the processor, according to the embodiment of FIG. 1.

FIG. 3A shows an example window in which a three-dimensional graphical representation of a multi-screen display device is displayed, according to the embodiment of FIG. 1.

FIG. 3B shows the example window of FIG. 3A after the processor has received a pose modification input that includes moving a slider.

FIG. 3C shows the example window of FIG. 3A after the processor has received a pose modification input that includes selecting and dragging a portion of the three-dimensional representation.

FIG. 3D shows the example window of FIG. 3A after the processor has received an emulated user input.

FIG. 4 shows an example two-dimensional graphical representation of a multi-screen display device, according to the embodiment of FIG. 1.

FIG. 5A shows a flowchart of an example method for use with a computing device, according to the embodiment of FIG. 1.

FIGS. 5B-5C show additional steps that may optionally be performed as part of the method of FIG. 4A.

FIG. 6 shows a schematic representation of an example computing system, according to one embodiment of the present disclosure.

### DETAILED DESCRIPTION

As discussed above, existing emulators may, due to differences between the input and output devices included in the emulated devices and the devices on which the emulators are run, inaccurately represent the experience of using the emulated device. In particular, when emulating a device that includes multiple screens, all the screens may not always be visible from a single viewing angle. Changes in the orientations of the screens relative to each other may be particularly difficult to represent accurately on a single flat display.

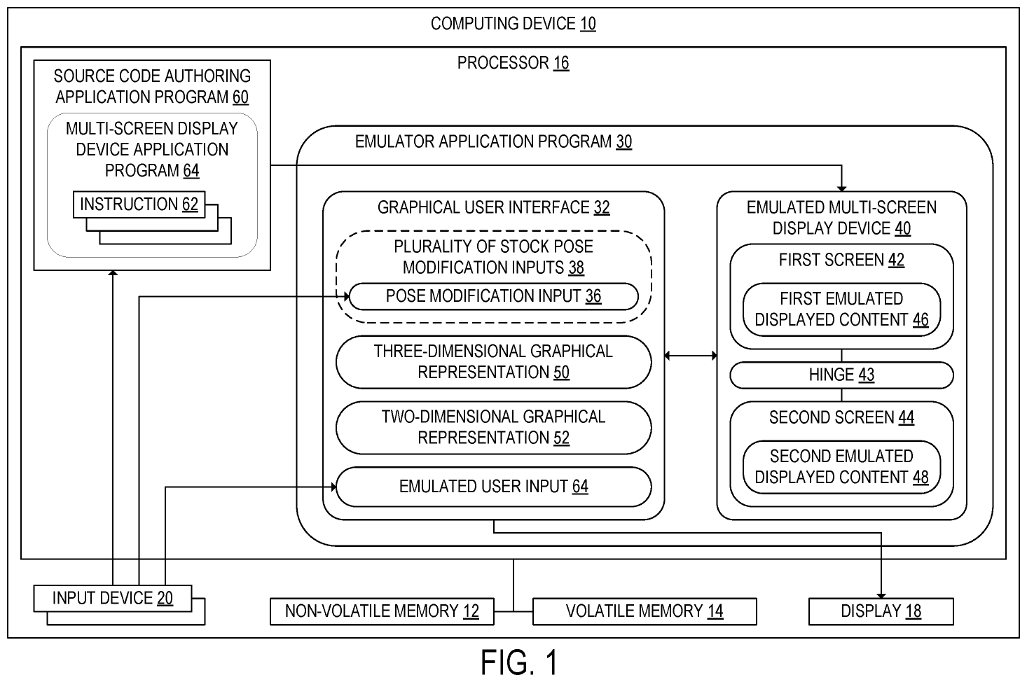

In order to address these challenges, a computing device 10 is provided, as schematically depicted in the example embodiment of FIG. 1. The computing device 10 may include non-volatile memory 12 and may further include volatile memory 14. The computing device 10 may further include a processor 16 operatively coupled to the non-volatile memory 12. The computing device 10 may further include a display 18, which may be operatively coupled to the processor 16. In some embodiments, the computing device 10 may include other output devices, such as one or more speakers or haptic feedback devices. The computing device 10 may further include one or more input devices 20, which may include one or more of a touchscreen, a keyboard, a trackpad, a mouse, a button, a microphone, a camera, and/or an accelerometer. Other types of input devices 20 and/or output devices may be included in some embodiments of the computing device 10.

The processor 16 of the computing device 10 may be configured to execute an emulator application program 30. When the processor 16 executes the emulator application program 30, the processor 16 may be configured to output a graphical user interface (GUI) 32 of the emulator application program 30 for display on the display 18. The GUI 32 may include a three-dimensional graphical representation 50 of an emulated multi-screen display device 40 including at least a first screen 42 and a second screen 44. First emulated displayed content 46 may be displayed on the first screen 42 of the emulated multi-screen display device 40. In some embodiments, second emulated displayed content may additionally or alternatively be displayed on the second screen 44 of the emulated multi-screen display device 40. In some embodiments, the emulated multi-screen display device 40 may include three or more screens.

In some embodiments, the processor 16 may be further configured to output a two-dimensional graphical representation 52 of the emulated multi-screen display device 40 for display on the display 18. The two-dimensional graphical representation 52 may be included in the GUI 32 of the emulator application program 30. The two-dimensional graphical representation 52 may include a two-dimensional representation of the first screen 42 and/or the second screen 44 and may show a two-dimensional view of the first emulated displayed content 46 and/or the second emulated displayed content 48.

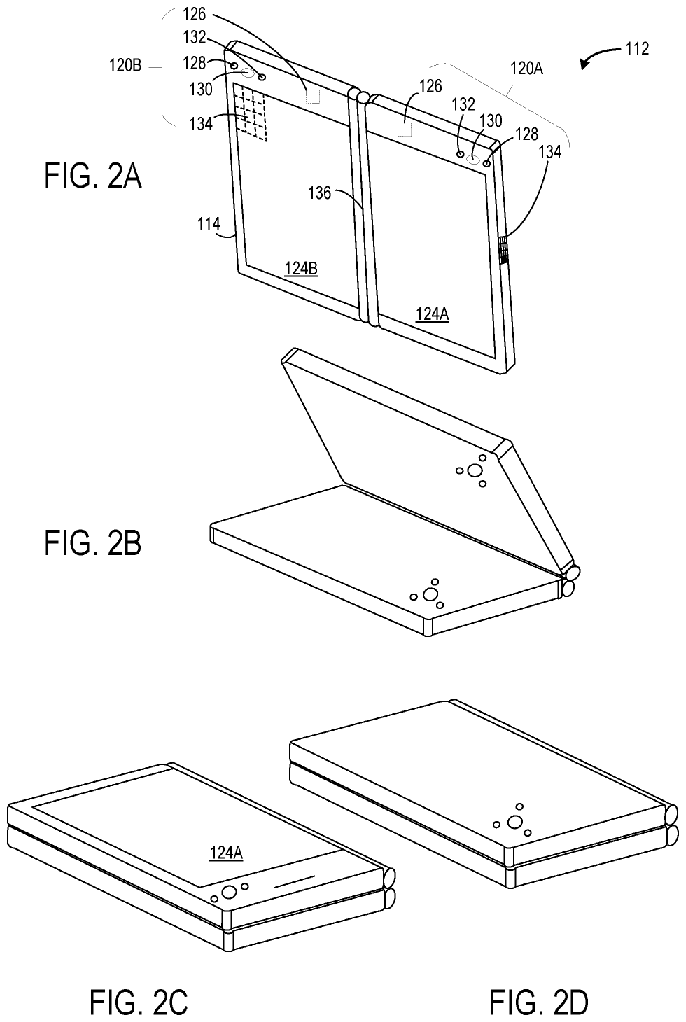

FIGS. 2A-D show an example embodiment of the multi-screen display device 112 that may be emulated by the processor 16 of the computing device 10. As shown, the example multi-screen display device 112 may include a housing 114 and example display devices 124A and 124B, which may be emulated as the first screen 42 and the second screen 44 of FIG. 1. The housing 114 may be configured to internally house various electronic components of the example multi-screen display device 112. Additionally, the housing 114 may provide structural support for sensor arrays 120A and 120B respectively included in display devices 124A and 124B. In the illustrated example, the sensor arrays 120A and 120B may include one or more accelerometers 126 that are contained by the housing 114. The sensor arrays 120A and 120B may further include forward facing cameras 130. In one example, the forward-facing cameras 130 may include RGB cameras. However, it will be appreciated that other types of cameras may also be included in the forward-facing cameras 130. In this example, forward facing is a direction of the camera's associated display device. Thus, in the example of FIG. 2A, as the screens for both of an example pair of display devices 124A and 124B are facing the same direction, both of the forward-facing cameras 130 are also facing the same direction. The sensor arrays 120 may further include at least one ambient light sensor 128 and at least one depth camera 132.

As shown, the sensor arrays 120A and 120B may also include capacitive touch sensors 134 that are integrated with the pair of display devices 124A and 124B. The capacitive touch sensors 134 may include a capacitive grid configured to sense changes in capacitance caused by objects on or near the display devices, such as a user's finger, hand, stylus, pen, etc. In one embodiment, the capacitive touch sensors 134 may also be included on one or more sides of the multi-screen display device 112. For example, the capacitive touch sensors 134 may be additionally integrated into the sides of the housing 114 of the multi-screen display device 112. In other examples, the sensor arrays 120A and 120B may include camera-in-pixel devices integrated with each display device including the pair of display devices 124A and 124B. It will be appreciated that the sensor arrays 120 may include other sensors not illustrated in FIG. 2A.

In the example multi-screen display device 112 illustrated in FIG. 2A, the two example display devices 124A and 124B may be movable relative to each other. As shown, the housing including a hinge 136 between a pair of display devices 124A and 124B of the two or more display devices 124, the hinge 136 being configured to permit the pair of display devices 124A and 124B to rotate between angular orientations from a face-to-face angular orientation to a back-to-back angular orientation.

Now turning to FIG. 2B, the hinge 136 permits the pair of display devices 124A and 124B to rotate relative to one another such that an angle between the pair of display devices 124A and 124B can be decreased or increased. As shown in FIG. 2B, the pair of display devices 124A and 124B may be rotated until the pair of display devices 124A and 124B reach a back-to-back angular orientation as shown in FIG. 2C. As shown in FIG. 2D, the angular orientation between the pair of display devices 124A and 124B may also rotate to a face-to-face orientation where the pair of display devices face each other.

Returning to FIG. 1, the processor 16 may be further configured to receive a pose modification input 36 via an input device 20 of the one or more input devices 20 included in the computing device 10. The pose modification input 36 may include a modification to an angle between the first screen 42 and the second screen 44 of the emulated multi-screen display device 40. Additionally or alternatively to an angle modification, the pose modification input 36 may include a rotation of the emulated multi-screen display device 40. The modification to the angle between the first screen 42 and the second screen 44 may, in some embodiments, include movement of a hinge 43 coupled to the first screen 42 and the second screen 44. For example, when the multi-screen display device 112 of FIGS. 2A-D is emulated, the hinge 43 may be an emulated representation of the hinge 136. In embodiments in which the emulated multi-screen display device 40 includes three or more screens, the pose modification input 36 may include a modification to a plurality of angles between the screens. In such embodiments, the emulated multi-screen display device 40 may further include a plurality of hinges 43 between screens, and the pose modification input 36 may include movement of one or more hinges 43 of the plurality of hinges 43.

In response to receiving the pose modification input 36, the processor 16 may be further configured to modify a pose of the first screen 42 of the emulated multi-screen display device 40 relative to the second screen 44 of the emulated multi-screen display device 40. In embodiments in which the emulated multi-screen display device 40 includes a hinge 43 coupled to the first screen 42 and the second screen 44, modifying the pose of the first screen 42 relative to the second screen 44 may include moving the hinge 43. The processor 16 may be further configured to output the GUI 32, including the three-dimensional graphical representation 50 of the emulated multi-screen display device 40 with the modified pose, for display on the display 18.

The processor 16 may, in some embodiments, be further configured to receive at the emulator application program 30 one or more instructions 62 from a source code authoring application program 60. For example, at the source code authoring application program 60, a developer may write source code including one or more instructions 62 configured to be executed by the multi-screen display device. The source code may then be sent to the emulator application program 30 for testing and debugging. In such embodiments, the processor 16 may be further configured to output the GUI for display based at least in part on the one or more instructions. In embodiments in which emulated displayed content is displayed on at least one of the first screen 42 and the second screen 44, the emulated displayed content may be displayed based at least in part on the one or more instructions 62. The one or more instructions 62 may be included in a multi-screen display device application program configured to be executed on the multi-screen display device.

In some embodiments, the processor 16 may be further configured to receive an emulated user input 64 at the three-dimensional graphical representation 50 of the emulated multi-screen display device 40. For example, the emulated user input 64 may be an emulated touch input received at the first screen 42 and/or the second screen 44. Alternatively, the emulated user input 64 may be some other form of input, such as a button press, a camera input, an accelerometer input, or a microphone input. The emulated user input 64 may be received from the one or more input devices 20 of the computing device 10 and may or may not be of the same type as the input with which it is entered at the one or more input devices 20. For example, a mouse click performed at a mouse included in the one or more input devices 20 of the computing device 10 may indicate an emulated user input 64 that is a touch input. In response to receiving the emulated user input 64, the processor 16 may be further configured to modify the first emulated displayed content 46 and/or the second emulated displayed content 48 respectively displayed on the first screen 42 and/or the second screen 44 of the emulated multi-screen display device 40 based on the emulated user input 64.

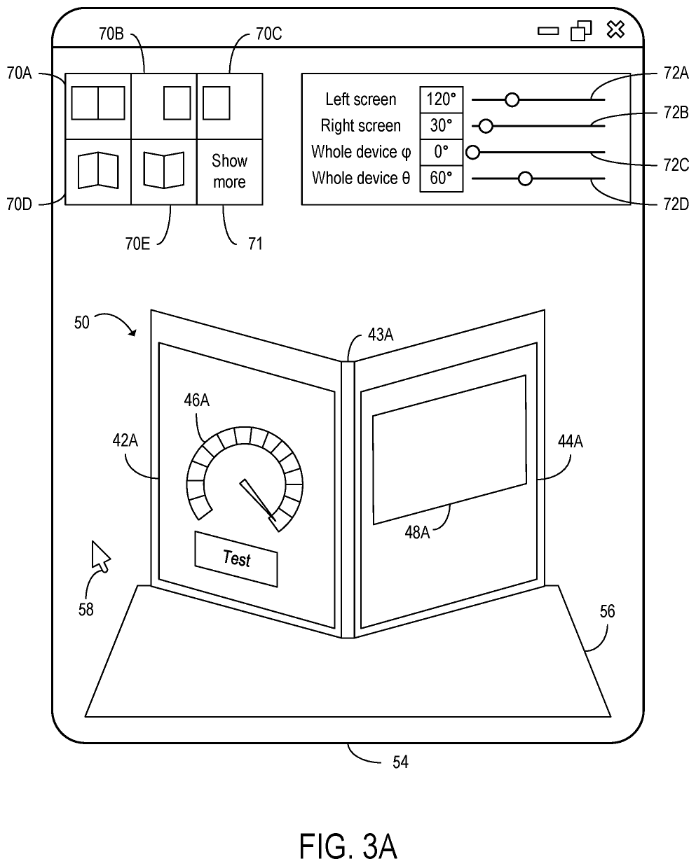

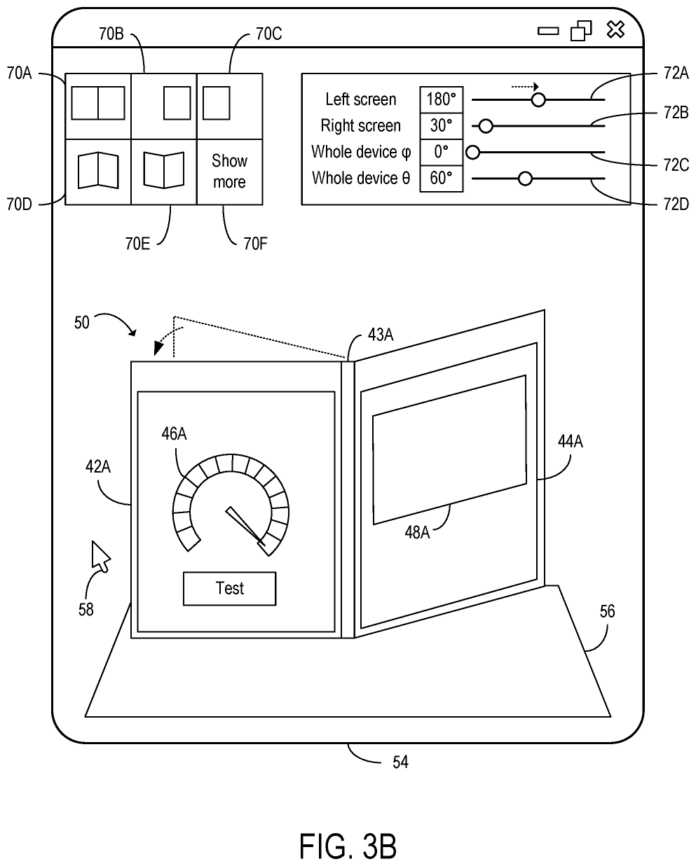

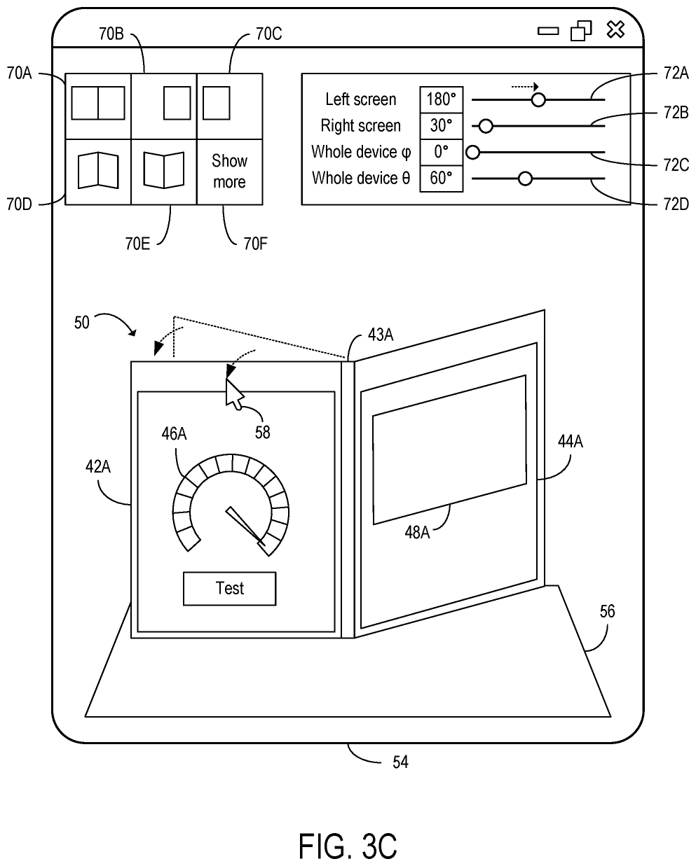

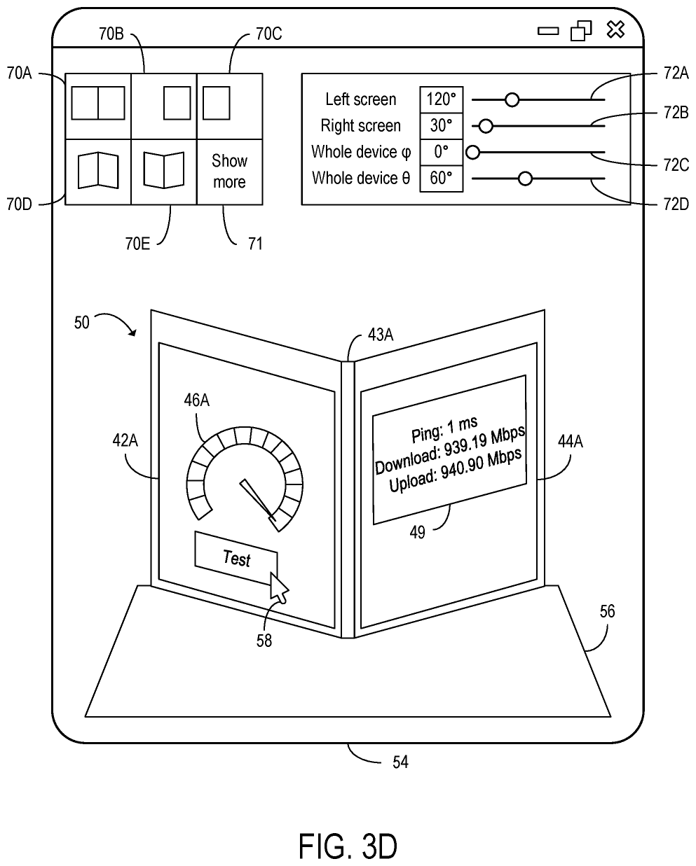

FIG. 3A shows an example window 54 that may be included in the GUI 32 of the emulator application program 30, according to one example embodiment. The window 54 shown in FIG. 3A includes a three-dimensional graphical representation 50 of the emulated multi-screen display device 40. The processor 16 may receive user input at the GUI 32 via the one or more input devices 20 of the computing device 10. For example, the GUI 32 may include a cursor 58 that may be used to select GUI elements in response to input received from a mouse or trackpad. GUI elements included in the GUI 32 may additionally or alternatively be selected in response to inputs received from other input devices 20.

The three-dimensional graphical representation 50 displayed in the window 54 includes three-dimensional representations of the first screen 42A, the hinge 43A, and the second screen 44A. In addition, three-dimensional representations of the first emulated displayed content 46A and second emulated displayed content 48A are shown on the first screen 42A and the second screen 44A respectively. In the example embodiment of FIG. 3A, a connection speed testing application program is emulated on the emulated multi-screen display device 40, and the first emulated displayed content 46A and second emulated displayed content 48A are generated based on the emulated connection speed testing application program. The window 54 shown in FIG. 3A further includes a background 56 over which the three-dimensional graphical representation 50 of the emulated multi-screen display device 40 is displayed.

The processor 16 may receive a pose modification input 36 via user interaction with the GUI 32. In some embodiments, the pose modification input 36 may be a stock pose modification input 38 selected from a plurality of stock pose modification inputs 38. In the example of FIG. 3A, the window 54 includes a plurality of stock pose icons depicted as thumbnail images of stock poses of the multi-screen display device 40. The plurality of stock pose icons include a side-by-side stock pose icon 70A, a folded-with-right-screen-visible stock pose icon 70B, a folded-with-left-screen-visible stock pose icon 70C, a partially-folded-inward stock pose icon 70D, and a partially-folded-inward stock pose icon 70E. A “Show more” icon 71 is also displayed. In response to an input selecting a stock pose icon, the processor 16 may be configured to modify the pose of the emulated multi-screen display device 40 to have the selected stock pose. When the “Show more” icon 71 is selected, the GUI 32 may display one or more additional stock pose icons.

In another example, the GUI 32 of the emulator application program 30 may include the stock pose icons 70A, 70B, 70C, 70D, and 70E as menu items displayed in a drop-down menu. Other example configurations of the GUI 32 to enable selection of stock pose modification inputs 38 are also contemplated. In some embodiments, the GUI 32 may include functionality for a user to generate a new stock pose modification input 38. The new stock pose modification input 38 may, for example, be displayed as a stock pose icon as in the example of FIG. 3A.

The GUI 32 of the emulator application program 30 may additionally or alternatively allow the pose of the three-dimensional graphical representation 50 of the emulated multi-screen display device 40 to be modified via other means. In the example of FIG. 3A, the window 54 further includes a plurality of sliders. The plurality of sliders shown in FIG. 3A include a left screen slider 72A, a right screen slider 72B, a whole device φ slider 72C, and a whole device θ slider 72D. In response to a pose modification input 36 interacting with one or more slider of the plurality of sliders, the processor 16 may modify the pose of the three-dimensional graphical representation 50. The left screen slider 72A and the right screen slider 72D may enable modification of the respective angles of the first screen 42A and the second screen 44A relative to the hinge 43A in the three-dimensional representation 50. The whole device φ slider 72C and the whole device θ slider 72D may enable modification of respective azimuthal and polar angles at which the three-dimensional representation 50 of the emulated multi-screen display device 40 is viewed, as expressed in spherical coordinates. In some embodiments, other coordinate systems may be used.

Each slider shown in FIG. 3A additionally has an associated text entry field in which the user may enter a numerical value for a position of the slider in order to move the slider. As shown in the embodiment of FIG. 3A, the numerical values for the positions of the sliders are given in terms of degrees. In other embodiments, the numerical values for the positions of the sliders may be expressed differently, for example, in Cartesian coordinates.

FIG. 3B shows the example window 54 of FIG. 3A after the left screen slider 72A has been moved to the left so that it is positioned at the center of its range. The left screen slider 72A may be moved by a pose modification input 36, which may be a mouse input, a touch input, or some other type of input. In response to the movement of the left screen slider 72A, the first screen 42A is repositioned to face toward the user.

In embodiments in which the sliders have associated text entry fields, as shown in FIGS. 3A-B, in response to the user entering a numerical value for the position of a slider, the processor 16 may also modify the pose or view with which the three-dimensional representation 50 of the emulated multi-screen display device 40 is displayed. When the pose of the three-dimensional representation 50 is modified at a text entry field, the processor 16 may be further configured to move the slider associated with that text entry field to reflect the entered numerical value.

Additionally or alternatively, as shown in FIG. 3C, the pose modification input 36 may be an input that selects at least a portion of the three-dimensional representation 50 and drags the portion to a modified position. For example, the pose modification input 36 may be a click and drag input performed using a mouse. Alternatively, the pose modification input 36 may be a touch input. As shown in FIG. 3C, the processor 16 may be further configured to modify at least one slider and/or text entry field to reflect the modified position.

When the processor 16 receives a pose modification input 36, the processor 16 may be further configured to animate modification of the pose of the emulated multi-screen display device 40. For example, when a slider is moved from a position indicating a first pose to a position indicating a second pose, the GUI 32 may show the three-dimensional graphical representation 50 of the emulated multi-screen display device 40 in one or more intermediate poses between the first pose and the second pose. Pose modifications made in response to other pose modification inputs 36, such as selection of a stock pose icon, may additionally or alternatively be animated.

FIG. 3D shows the example three-dimensional representation 50 the emulated multi-screen display device 40 of FIG. 3A after an emulated user input 64 has been received at the GUI 32 of the emulator application program 30. In the example of FIG. 3D, the emulated user input 64 is an emulated touch input that is entered as a mouse input at the computing device 10. The emulated user input 64 selects a “Test” button associated with the emulated connection speed testing application program. In response to the emulated user input 64, emulated connection speed testing results are displayed as modified second displayed content 49 on the second screen 44A of the three-dimensional graphical representation 50.

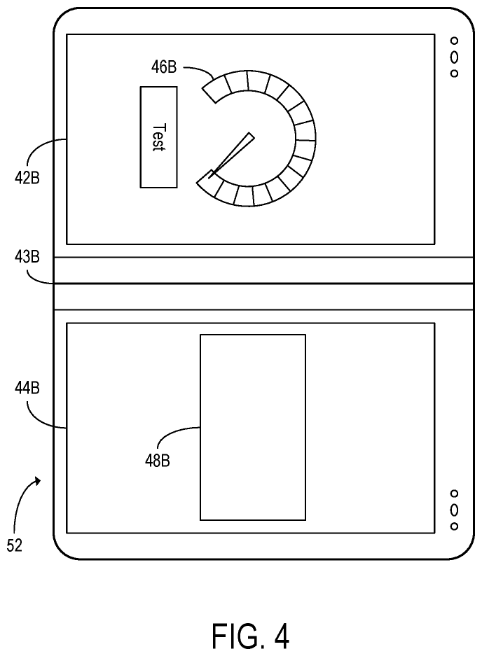

In some embodiments, the GUI 32 of the emulator application program 30 may include a two-dimensional graphical representation 52 of the emulated multi-screen display device 40, as shown in FIG. 4. Displaying a two-dimensional graphical representation 52 of the emulated multi-screen display device 40 in addition to a three-dimensional graphical representation 50 may be desirable, for example, when the emulated multi-screen display device 40 is posed in the three-dimensional graphical representation 50 such that some or all of at least one screen is obscured.

The two-dimensional graphical representation 52 of the emulated multi-screen display device 40 shown in FIG. 4 includes two-dimensional representations of the first screen 42B, the hinge 43B, and the second screen 44B. Two-dimensional representations of the first emulated displayed content 46B and the second emulated displayed content 48B are displayed on the first screen 42B and the second screen 44B respectively. In the embodiment of FIG. 4, the first emulated displayed content 46B and the second emulated displayed content 48B are associated with the connection speed testing application program of FIGS. 3A-C. Although not shown in FIG. 4, the two-dimensional graphical representation 52 may be displayed in a window in the GUI 32. Additionally or alternatively, one or more GUI elements at which a pose modification input 36 may be received may be displayed with the two-dimensional graphical representation 52. For example, in embodiments in which the two-dimensional graphical representation 52 is displayed in a window, one or more stock pose icons and/or sliders may be displayed in the window.

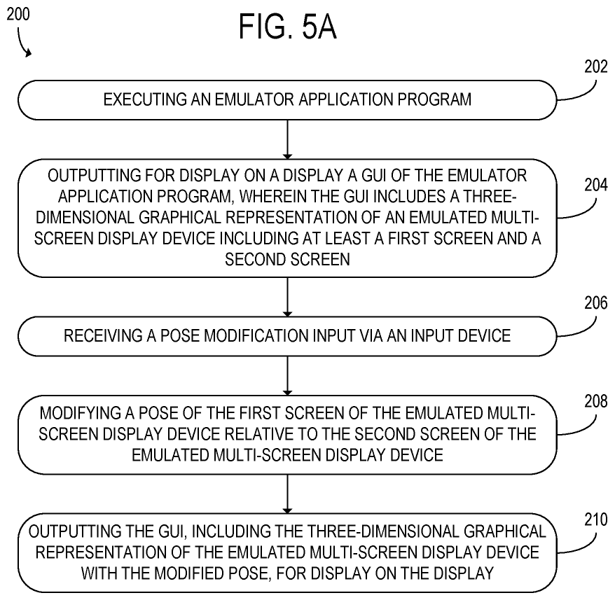

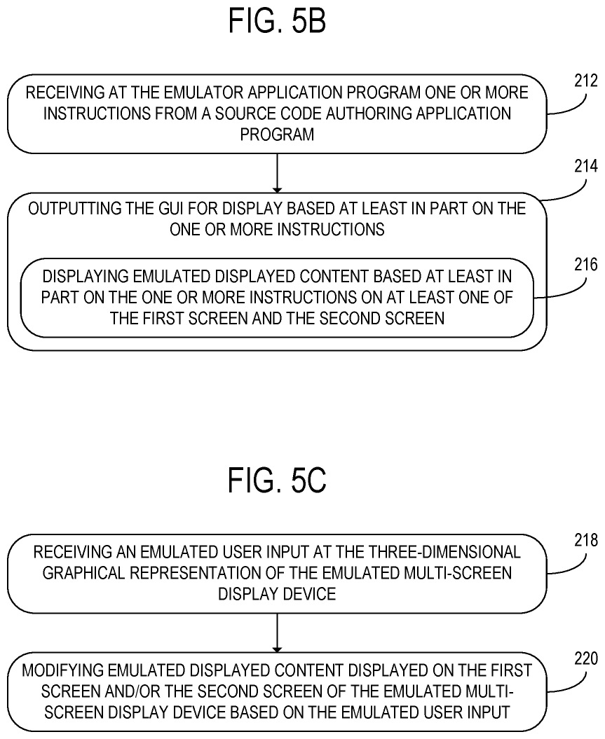

FIG. 5A shows a flowchart of an example method 200 for use with a computing device. The method 200 may be used with the computing device 10 of FIG. 1, or alternatively with some other computing device. The method 200 may include, at step 202, executing an emulator application program. The emulator application program may be executed at a processor of the computing device. At step 204, the method 200 may further include outputting for display on a display a GUI of the emulator application program. The GUI may include a three-dimensional graphical representation of an emulated multi-screen display device including at least a first screen and a second screen. In some embodiments, the GUI may further include a two-dimensional graphical representation of the emulated multi-screen display device. Additionally or alternatively, in some embodiments, the emulated multi-screen display device may include three or more screens.

At step 206, the method 200 may further include receiving a pose modification input via an input device. The pose modification input may be received via the GUI. In response to receiving the pose modification input, the method 200 may further include, at step 208, modifying a pose of the first screen of the emulated multi-screen display device relative to the second screen of the emulated multi-screen display device. For example, the pose modification input may be a stock pose modification input selected from a plurality of stock pose modification inputs. In response to receiving a stock pose modification input, step 208 may include modifying the pose of the first screen relative to the second screen to have a predefined stock pose specified by the stock pose modification input.

In some embodiments, the pose modification input may include a modification to an angle between the first screen and the second screen. For example, in some embodiments, the emulated multi-screen display device may include a hinge coupled to the first screen and the second screen. In such embodiments, the pose modification may include movement of the hinge. In embodiments in which the emulated multi-screen display device includes three or more screens, the pose modification input may include a modification to a plurality of angles between screens. The emulated multi-screen display device may, in such embodiments, include a plurality of hinges.

At step 210, the method 200 may further include outputting the GUI, including the three-dimensional graphical representation of the emulated multi-screen display device with the modified pose, for display on the display. In some embodiments, step 210 may include animating modification of the pose of the emulated multi-screen display device.

FIGS. 5B and 5C show additional steps that may optionally be performed as part of the method 200 in some embodiments. In FIG. 5B, at step 212, the method 200 may further include receiving at the emulator application program one or more instructions from a source code authoring application program. The one or more instructions received from the source code authoring application program may be configured to be executed at the multi-screen display device.

At step 214, the method 200 may further include outputting the GUI for display based at least in part on the one or more instructions. In some embodiments, step 214 may include, at step 216, displaying emulated displayed content based at least in part on the one or more instructions on at least one of the first screen and the second screen. In such embodiments, the emulated displayed content may be generated by executing the one or more instructions at the emulated multi-screen display device.

As shown in FIG. 5C, at step 218, the method 200 may further include receiving an emulated user input at the three-dimensional graphical representation of the emulated multi-screen display device. The emulated user input may be received via an input device included in the computing device at which the method 200 is performed. The emulated user input may include an interaction with one or more GUI elements included in the GUI of the emulator application program. At step 220, the method 200 may further include modifying emulated displayed content displayed on the first screen and/or the second screen of the emulated multi-screen display device based on the emulated user input. For example, user interaction with an application program executed at the multi-screen display device may be emulated.

In some embodiments, the methods and processes described herein may be tied to a computing system of one or more computing devices. In particular, such methods and processes may be implemented as a computer-application program or service, an application-programming interface (API), a library, and/or other computer-program product.

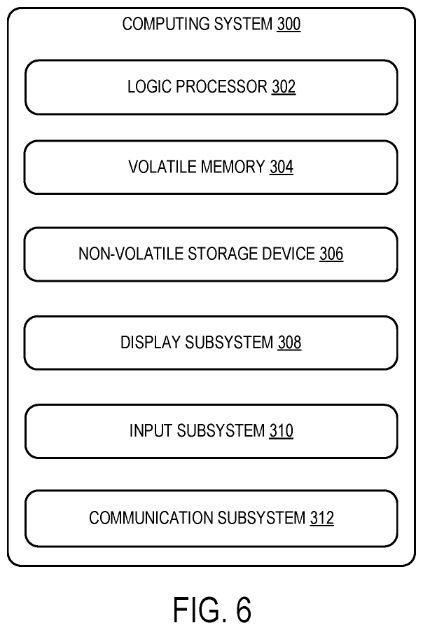

FIG. 6 schematically shows a non-limiting embodiment of a computing system 300 that can enact one or more of the methods and processes described above. Computing system 300 is shown in simplified form. Computing system 300 may embody the computing device 10 described above and illustrated in FIG. 1. Computing system 300 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 300 includes a logic processor 302, volatile memory 304, and a non-volatile storage device 306. Computing system 300 may optionally include a display subsystem 308, input subsystem 310, communication subsystem 312, and/or other components not shown in FIG. 6.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 300 to send and/or receive messages to and/or from other devices via a network such as the Internet.

According to one aspect of the present disclosure, a computing device is provided, including one or more input devices, a display, and a processor. The processor may be configured to execute an emulator application program. The processor may be further configured to output for display on the display a graphical user interface (GUI) of the emulator application program. The GUI may include a three-dimensional graphical representation of an emulated multi-screen display device including at least a first screen and a second screen. The processor may be further configured to receive a pose modification input via an input device of the one or more input devices. In response to receiving the pose modification input, the processor may be further configured to modify a pose of the first screen of the emulated multi-screen display device relative to the second screen of the emulated multi-screen display device. The processor may be further configured to output the GUI, including the three-dimensional graphical representation of the emulated multi-screen display device with the modified pose, for display on the display.

According to this aspect, the processor may be further configured to receive at the emulator application program one or more instructions from a source code authoring application program. The processor may be further configured to output the GUI for display based at least in part on the one or more instructions. According to this aspect, emulated displayed content based at least in part on the one or more instructions may be displayed on at least one of the first screen and the second screen.

According to this aspect, the pose modification input may include a modification to an angle between the first screen and the second screen. According to this aspect, the emulated multi-screen display device may include a hinge coupled to the first screen and the second screen.

According to this aspect, the processor may be further configured to animate modification of the pose of the emulated multi-screen display device.

According to this aspect, the GUI may include a two-dimensional graphical representation of the emulated multi-screen display device.

According to this aspect, the pose modification input may be a stock pose modification input selected from a plurality of stock pose modification inputs. In response to receiving the stock pose modification input, the processor may be configured to modify the pose of the first screen relative to the second screen to have a predefined stock pose specified by the stock pose modification input.

According to this aspect, the processor may be further configured to receive an emulated user input at the three-dimensional graphical representation of the emulated multi-screen display device. The processor may be further configured to modify emulated displayed content displayed on the first screen and/or the second screen of the emulated multi-screen display device based on the emulated user input.

According to this aspect, the emulated user input may be an emulated touch input received at the first screen and/or the second screen.

According to this aspect, the emulated multi-screen display device may include three or more screens.

According to another aspect of the present disclosure, a method for use with a computing device is provided. The method may include executing an emulator application program. The method may further include outputting for display on a display a graphical user interface (GUI) of the emulator application program. The GUI may include a three-dimensional graphical representation of an emulated multi-screen display device including at least a first screen and a second screen. The method may further include receiving a pose modification input via an input device. In response to receiving the pose modification input, the method may further include modifying a pose of the first screen of the emulated multi-screen display device relative to the second screen of the emulated multi-screen display device. The method may further include outputting the GUI, including the three-dimensional graphical representation of the emulated multi-screen display device with the modified pose, for display on the display.

According to this aspect, the method may further include receiving at the emulator application program one or more instructions from a source code authoring application program. The method may further include outputting the GUI for display based at least in part on the one or more instructions. According to this aspect, the method may further include displaying emulated displayed content based at least in part on the one or more instructions on at least one of the first screen and the second screen.

According to this aspect, the pose modification input may include a modification to an angle between the first screen and the second screen. According to this aspect, the emulated multi-screen display device may include a hinge coupled to the first screen and the second screen.

According to this aspect, the GUI may include a two-dimensional graphical representation of the emulated multi-screen display device.

According to this aspect, the method may further include receiving an emulated user input at the three-dimensional graphical representation of the emulated multi-screen display device. The method may further include modifying emulated displayed content displayed on the first screen and/or the second screen of the emulated multi-screen display device based on the emulated user input.

According to this aspect, the emulated multi-screen display device may include three or more screens.

According to another aspect of the present disclosure, a computing device is provided, including one or more input devices, a display, and a processor. The processor may be configured to receive one or more instructions from a source code authoring application program at an emulator application program. The processor may be further configured to output for display on the display, based at least in part on the one or more instructions, a three-dimensional graphical representation of an emulated multi-screen display device including at least a first screen and a second screen. The processor may be further configured to output for display on the display, based at least in part on the one or more instructions, a two-dimensional graphical representation of the emulated multi-screen display device. The processor may be further configured to receive a pose modification input via an input device of the one or more input devices. In response to receiving the pose modification input, the processor may be further configured to modify a pose of the first screen of the emulated multi-screen display device relative to the second screen of the emulated multi-screen display device. The processor may be further configured to output the three-dimensional graphical representation and the two-dimensional graphical representation of the emulated multi-screen display device with the modified pose for display on the display.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
one or more input devices;
a display; and
a processor configured to:
execute an emulator application program;
output for display on the display a graphical user interface (GUI) of the emulator application program, wherein the GUI includes a three-dimensional graphical representation of an emulated multi-screen display device including at least a first screen and a second screen;
receive a pose modification input via an input device of the one or more input devices;
in response to receiving the pose modification input, modify a pose of the first screen of the emulated multi-screen display device relative to the second screen of the emulated multi-screen display device; and
output the GUI, including the three-dimensional graphical representation of the emulated multi-screen display device with the modified pose, for display on the display.

2. The computing device of claim 1, wherein the processor is further configured to:
receive at the emulator application program one or more instructions from a source code authoring application program; and
output the GUI for display based at least in part on the one or more instructions.

3. The computing device of claim 2, wherein emulated displayed content based at least in part on the one or more instructions is displayed on at least one of the first screen and the second screen.

4. The computing device of claim 1, wherein the pose modification input includes a modification to an angle between the first screen and the second screen.

5. The computing device of claim 4, wherein the emulated multi-screen display device includes a hinge coupled to the first screen and the second screen.

6. The computing device of claim 1, wherein the processor is further configured to animate modification of the pose of the emulated multi-screen display device.

7. The computing device of claim 1, wherein the GUI includes a two-dimensional graphical representation of the emulated multi-screen display device.

8. The computing device of claim 1, wherein:
the pose modification input is a stock pose modification input selected from a plurality of stock pose modification inputs; and
in response to receiving the stock pose modification input, the processor is configured to modify the pose of the first screen relative to the second screen to have a predefined stock pose specified by the stock pose modification input.

9. The computing device of claim 1, wherein the processor is further configured to:
receive an emulated user input at the three-dimensional graphical representation of the emulated multi-screen display device; and
modify emulated displayed content displayed on the first screen and/or the second screen of the emulated multi-screen display device based on the emulated user input.

10. The computing device of claim 9, wherein the emulated user input is an emulated touch input received at the first screen and/or the second screen.

11. The computing device of claim 1, wherein the emulated multi-screen display device includes three or more screens.

12. A method for use with a computing device, the method comprising:
executing an emulator application program;
outputting for display on a display a graphical user interface (GUI) of the emulator application program, wherein the GUI includes a three-dimensional graphical representation of an emulated multi-screen display device including at least a first screen and a second screen;
receiving a pose modification input via an input device;
in response to receiving the pose modification input, modifying a pose of the first screen of the emulated multi-screen display device relative to the second screen of the emulated multi-screen display device; and
outputting the GUI, including the three-dimensional graphical representation of the emulated multi-screen display device with the modified pose, for display on the display.

13. The method of claim 12, further comprising:
receiving at the emulator application program one or more instructions from a source code authoring application program; and
outputting the GUI for display based at least in part on the one or more instructions.

14. The method of claim 13, further comprising displaying emulated displayed content based at least in part on the one or more instructions on at least one of the first screen and the second screen.

15. The method of claim 12, wherein the pose modification input includes a modification to an angle between the first screen and the second screen.

16. The method of claim 15, wherein the emulated multi-screen display device includes a hinge coupled to the first screen and the second screen.

17. The method of claim 12, wherein the GUI includes a two-dimensional graphical representation of the emulated multi-screen display device.

18. The method of claim 12, further comprising:
receiving an emulated user input at the three-dimensional graphical representation of the emulated multi-screen display device; and
modifying emulated displayed content displayed on the first screen and/or the second screen of the emulated multi-screen display device based on the emulated user input.

19. The method of claim 12, wherein the emulated multi-screen display device includes three or more screens.

20. A computing device, comprising:
one or more input devices;
a display; and
a processor configured to:
receive one or more instructions from a source code authoring application program at an emulator application program;
output for display on the display, based at least in part on the one or more instructions, a three-dimensional graphical representation of an emulated multi-screen display device including at least a first screen and a second screen;
output for display on the display, based at least in part on the one or more instructions, a two-dimensional graphical representation of the emulated multi-screen display device;
receive a pose modification input via an input device of the one or more input devices;
in response to receiving the pose modification input, modify a pose of the first screen of the emulated multi-screen display device relative to the second screen of the emulated multi-screen display device; and
output the three-dimensional graphical representation and the two-dimensional graphical representation of the emulated multi-screen display device with the modified pose for display on the display.
